(19) United States
(12) Patent Application Publication
(10) Pub. No.: US 2011/0191775 A1
(43) Pub. Date: Aug. 4, 2011

(54) ARRAY-BASED THREAD COUNTDOWN

(75) Inventors: Emad A. Omara, Bellevue, WA (US); John J. Duffy, Seattle, WA (US)

(73) Assignee: Microsoft Corporation, Redmond, WA (US)

(21) Appl. No.: 12/697,035

(22) Filed: Jan. 29, 2010

(51) Int. Cl. G06F 9/46

(52) U.S. Cl. 718/102

(57) ABSTRACT

The forking of thread operations. At runtime, a task is identified as being divided into multiple subtasks to be accomplished by multiple threads (i.e., forked threads). In order to be able to verify when the forked threads have completed their task, multiple counter memory locations are set up and updated as forked threads complete. The multiple counter memory locations are evaluated in the aggregate to determine whether all of the forked threads are completed. Once the forked threads are determined to be completed, a join operation may be performed. Rather than a single memory location, multiple memory locations are used to account for thread completion. This reduces risk of thread contention.

### BACKGROUND

Multi-processor computing systems are capable of executing multiple threads concurrently in a process often called parallel processing. One of the most simple and effective ways for obtaining good parallel processing is the fork/join parallelism. If a thread encounters a particular task that may be subdivided into multiple independent tasks, a fork operation may occur in which different threads are assigned different independent tasks. When all of the tasks are complete, the forked threads are joined to allow the initiating thread to continue work. Thus, in a fork/join parallelism, it is important to detect when the threads are all finished performing their respected forked subtasks.

One way to detect when all threads are completed is to set up a latch at the time the fork is initiated. The latch is initialized with a count of N, where N is the number of independent threads operating on forked subtasks by forked threads. As each forked thread completes its subtask, the thread signals the latch, which causes the latch to decrement the count by one. The completed forked threads may then wait on the latch. When the latch count reaches zero, that means that all forked threads have completed and signaled the latch. At this point, all of the threads are woken.

One implementation of this latch is to use a single integer variable that is set to the count of N at construction time, and decremented at each signal call. The latch is set when that variable became zero.

### BRIEF SUMMARY

At least one embodiment described herein relates to the forking of thread operations. At runtime, a task is identified as being divided into multiple subtasks to be accomplished by multiple threads (i.e., forked threads). In order to be able to verify when the forked threads have completed their task, multiple counter memory locations are set up and updated as forked threads complete. The multiple counter memory locations are evaluated in the aggregate to determine whether all of the forked threads are completed. Once the forked threads are determined to be completed, a join operation may be performed.

Rather than a single memory location, multiple memory locations are used to account for thread completion. This reduces risk of thread contention. In one embodiment, the memory locations correspond to the boundary of a cache line, rendering it even less likely that thread contention may occur.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a flowchart of a method for performing a thread concurrency fork and join operation;

FIG. 3 illustrates a thread having a task being split into multiple forked tasks completed, at different times, by multiple forked threads;

FIG. 4A illustrates a configuration of counter memory locations in which the number of counter memory locations is the same as the number of forked threads;

FIG. 4B illustrates a configuration of counter memory locations in which the number of counter memory locations is less than the number of forked threads; and

FIG. 4C illustrates a configuration of counter memory locations in which the number of counter memory locations is greater than the number of forked threads.

### DETAILED DESCRIPTION

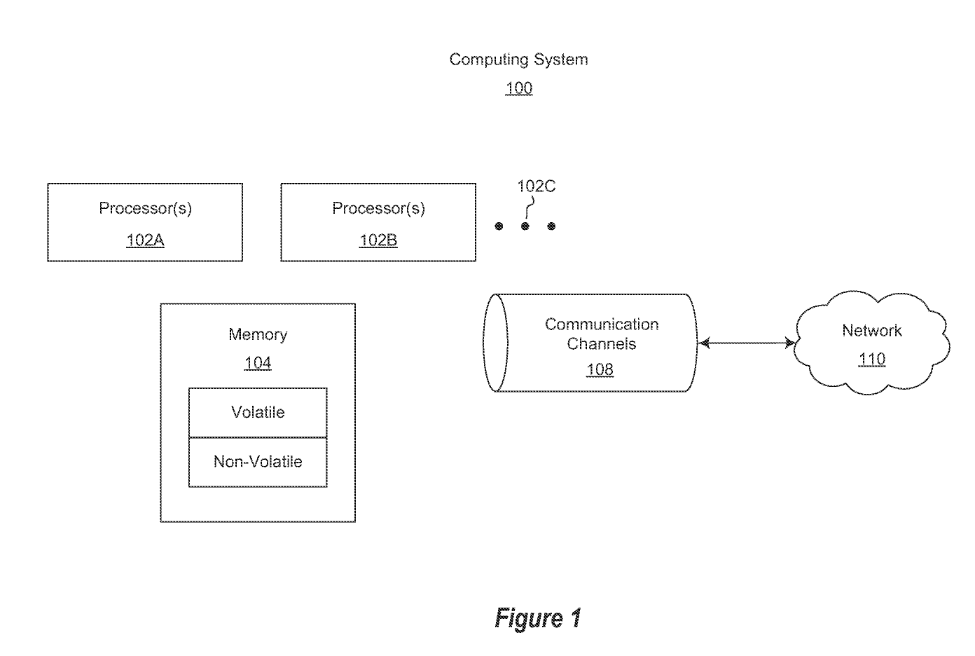

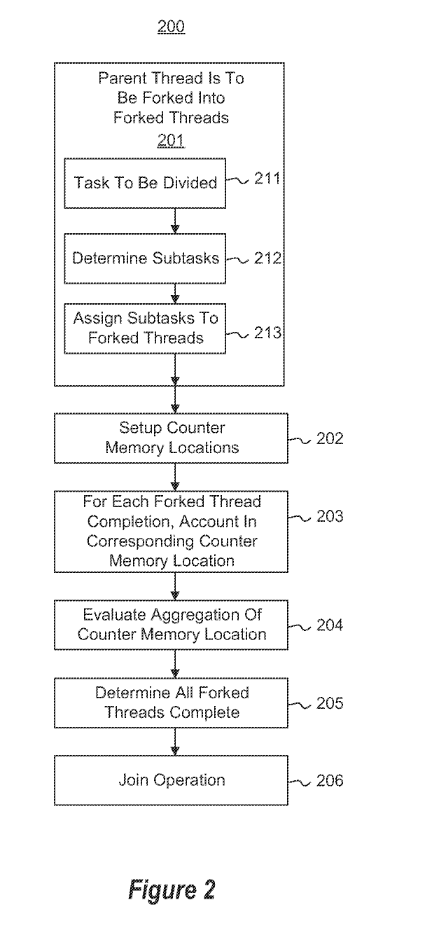

In accordance with embodiments described herein, the forking of thread operations is described. At runtime, a task is identified as being divided into multiple subtasks to be accomplished by multiple threads (i.e., forked threads). In order to be able to verify when the forked threads have completed their task, multiple counter memory locations are set up and updated as forked threads complete. The multiple counter memory locations are evaluated in the aggregate to determine whether all of the forked threads are completed. Once the forked threads are determined to be completed, a join operation may be performed. First, some introductory discussion regarding computing systems will be described with respect to FIG. 1. Then, various embodiments of use of forking operation will be described with reference to FIGS. 2 through 4C.

First, introductory discussion regarding a multi-processor computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a multi-processor computing system 100 typically at least two processors 102A and 102B, but may include more, perhaps many more, as represented by the ellipses 102C. The computing system 100 also includes memory 104, which may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include a computer program product having computer-readable media for carrying or having computer-executable instructions or data structures stored thereon. Such computer-readable media (or machine-readable media) can be any available media that can be accessed by a general purpose or special purpose computer. By way of example, and not limitation, such computer-readable media can comprise physical storage and/or memory media such as RAM, ROM, EEPROM, CD-ROM, DVD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

A computer program product comprising one or more physical computer-readable media having thereon computer-executable instructions that, when executed by one or more processors of the computing system, cause the computing system to perform a method comprising:

FIG. 2 illustrates a flowchart of a method 200 for performing a thread concurrency fork and join operation. The fork and join operation may, for example, be a mechanism for performing concurrency processing in the computing system 100 of FIG. 1, which is illustrated as including two processors 102A and 102B, but may include more, perhaps many more, as represented by the ellipses 102C.

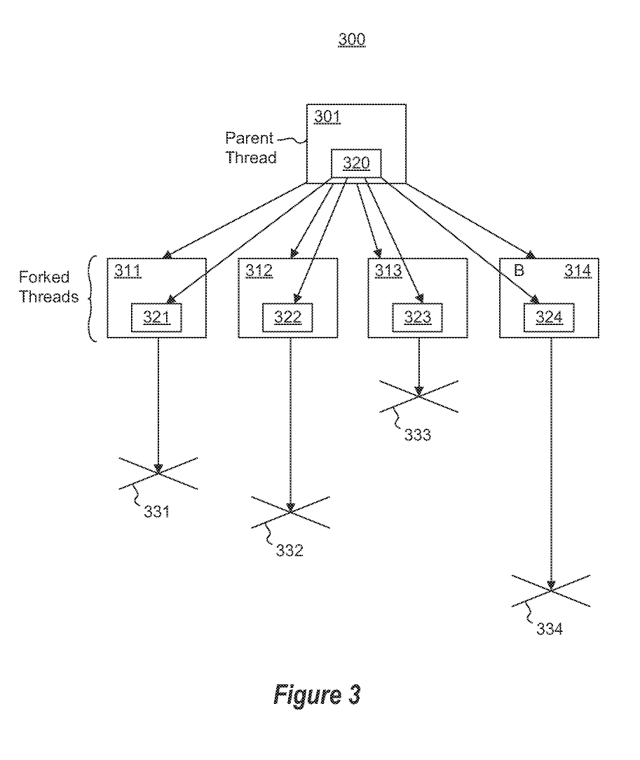

In a computing system such as that of FIG. 1, tasks are performed in response to the execution of computer-executable instructions present in memory 104. The operating system executes such instructions by assigning the task to a thread. For instance, referring to FIG. 3, task 320 is assigned to thread 301.

In a fork operation, the computing system 100 will often determine (perhaps with the help of the computer-executable instructions itself) that a task assigned to a parent thread is to be divided into subtasks to be collectively accomplished by a multiple forked threads (act 201). As an example, the task assigned to the thread is first determined to be divided (act 211), the independent subtasks are then identified (act 212), and then each subtasks is assigned to one of the forked threads (act 213).

Referring to FIG. 3 as an example, task 320 being accomplished by parent thread 301 is subdivided into subtasks 321, 322, 323 and 324, being accomplished by respective forked threads 311, 312, 313 and 314. However, in a fork operation, the parent task may be divided into any number of independent subtasks to be accomplished by any number of forked threads. Each of the respective forked threads 311 through 314 will complete their subtasks at different times as represented in FIG. 3 by symbols 331 through 334, respectively.

In this description and in the claims, a “parent” task is the task that is to be divided, and a “parent” thread is the thread that it to have its task divided. A “forked” task is a portion of the parent task that has been divided from the parent task, whereas a “forked” thread is a thread that has been assigned to accomplish the forked task(s). The parent thread need not be the main thread managed by the operating system. Nevertheless, the parent thread and the forked threads are managed by the operating system.

At some point, perhaps at the time the fork operation, but perhaps before, a number of counter memory locations are set up in memory (act 202). Each of the counter memory locations corresponds to only a subset of the forked threads. For instance, the counter memory locations may be located in memory 104 of the computing system 100 of FIG. 1.

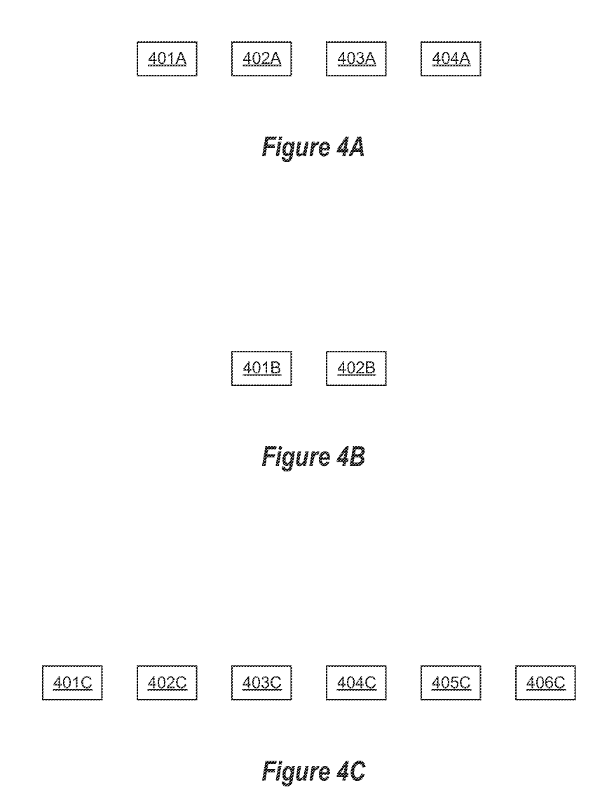

FIG. 4A illustrates four counter memory locations 401A, 402A, 403A and 404A. In this case, the number of the counter memory (i.e., four) is the same as the number of the forked threads (i.e., four). For instance, counter memory location 401A might be associated with forked thread 311, counter memory location 402A might be associated with forked thread 312, counter memory location 403A might be associated with forked threads 313 and 314, and counter memory location 404A might not be associated with any of the forked threads.

In the example of FIG. 4A, note that one of the counter memory locations 404A does not have a corresponding forked thread. That is within the scope of the principles described herein so long as there are at least two memory locations that do have a corresponding forked thread.

In one embodiment, the number of counter memory locations and the number of forked threads are the same, as in FIG. 4A, and each of the counter memory locations corresponds to a single one of the forked threads. In that example, referring to FIG. 4A, counter memory location 401A may be associated with forked thread 311, counter memory location 402A may be associated with forked thread 312, counter memory location 403A may be associated with forked thread 313, and counter memory location 404A may be associated with forked thread 314.

FIG. 4B illustrates an alternative in which there are only two counter memory locations 401B and 402B. Thus, this shows an example in which the number of the counter memory locations is less than the number of the plurality of forked threads. For instance, counter memory location 401B might be associated with forked threads 311 and 312, while counter memory location 402B might be associated with forked threads 313 and 314. However, there is no requirement that the counter memory locations be associated with the same number of forked threads. For instance, counter memory location 401B might be associated with only one forked thread 311, while counter memory location 402B might be associated with three forked threads 312, 313 and 314.

FIG. 4C illustrates an alternative in which there are six memory locations 401C, 402C, 403C, 404C, 405C and 406C. Thus, this shows an example in which the number of the counter memory locations (i.e., six) is greater than the number of forked threads (i.e., four). Here, not all of the counter memory locations will be associated with a forked thread. For instance, perhaps counter memory location 401C is associated with forked thread 311, counter memory location 403C is associated with forked thread 312, counter memory location 404C is associated with forked thread 313, and counter memory location 406C is associated with forked thread 314. However, counter memory locations 402C and 405C do not have an associated forked thread.

In one embodiment, the number of counter memory locations is initialized to be the number of forked threads multiplied by some positive number that is equal to or greater than one. For instance, in the case of FIG. 4A, that number of counter memory locations is the same as the number of threads. Accordingly, the positive number would be equal to one in that case. In the case of FIG. 4C, the positive number is 1.5 since there are six memory locations and four threads. In one specific embodiment, the positive number is a positive integer such as 1, 2, 3 and so forth. Thus, if the positive integer were 2, and if there were four forked threads, there would be eight memory locations initialized during the fork operation. In one embodiment, the counter memory locations are implemented as lock-free in which their content may be edited by the corresponding thread without locking the memory location.

In one embodiment, the forked thread is associated with the counter memory location through the thread identifier assigned by the operating system. The forked thread may be associated with the corresponding counter memory location by providing the thread identifier to a hash function that deterministically maps the thread identifier to a corresponding one of the counter memory locations. In another embodiment, as the forked threads are created, they are simply provided a newly generated counter memory location, and the system tracks the correlation.

As will be described further below, because there are multiple counter memory locations that may be updated as forked threads complete, there is less of a chance that any single one of the counter memory locations will be subject to contention. To further reduce the risk of contention, the counter memory locations may correspond to the size and boundaries of a cache line. Thus, since there would be no counter memory locations that are within the same cache line, there is an even further reduced chance of contention for any given counter memory location.

At this point, with each forked thread having a corresponding counter memory location, the forked threads may execute their respective subtasks. For instance, referring to FIG. 3, the forked threads 311, 312, 313 and 314 execute their respective subtasks 321, 322, 323 and 324. Although forked threads may complete their execution at the same time, this is not likely as each subtasks requires a different amount of work. Accordingly, in the example of FIG. 3, each forked thread 311 through 314 completes at different times 331 through 334.

Referring to FIG. 2, for each of the forked threads, when the forked thread is completed with its corresponding one or more subtasks, the completion is accounted for in the counter memory location corresponding to the forked thread (act 203). For instance, each memory location may have been originally initialized with a count of zero. The completion may be accounted for by incrementing the count in the corresponding counter memory location by one. Thus, when all of the forked threads have completed, the sum of the counts in all of the counter memory locations should be equal to the number of forked threads.

Accordingly, periodically, the method 300 evaluates the aggregate of all counter memory locations (act 204). For instance, this evaluation might be performed at periodic intervals, or perhaps each time a forked thread accounts for its completion in its corresponding counter memory location. In other words, the evaluation might be performed each time one of the counter memory locations is updated. In an alternative embodiment, there is an event that is initially un-signaled. Each time a thread updates its counter, a function evaluates the event, and if the total sum in all of the counter memory locations is equal to the total number of forked threads, the event is signaled and the function returns true. Otherwise, the function returns false.

After all of the plurality of subtasks have been collectively accomplished by the plurality of forked threads, this evaluation (act 204) will result in a determination that all of the forked threads have completed their respective one or more subtasks (act 205). For instance, if the sum of all of the counts of the counter memory locations is equal to the number tasks that were accomplished by the forked threads, then all of the forked threads likely checked in complete on all of their tasks (absent a fault condition). For instance, if forked thread A, B, C and D were each to accomplish one task a piece corresponding to task I, task II, task III, and task IV, then the total count of the aggregate of the counter memory locations would be equal to four, since one of the counter memory locations is updated whenever a task is complete. On the other hand, there might be just two forked threads A and B that collectively accomplish task I, task II, task III, and task IV. In that case, one or both of the forked threads may update the counter memory locations multiple times, whenever a forked task is completed.

At this point, a join operation may be performed on the forked threads (act 206). This allows the parent thread to continue processing other tasks.

The method 300 may be recursively performed. For instance, at any point, one of the forked threads may determine that its subtask may be divided. Such a determination might be made with the aid of additional processing by the forked thread as the forked thread accomplishes its subtask. At that stage, the forked thread would become a parent thread to two or more second generation forked threads. This may continue recursively without limit. However, for each level of recursion, the method would be repeated independently of the other levels of recursion with counter memory locations being set up for each level of recursion.

The following is a code example showing how the completion of each thread causes a corresponding counter memory location to be updated.

```
// Find slot in the current counts array (the array of counter memory
locations), and modify it.//
int tid = Thread.CurrentThread.ManagedThreadId %
m_currentCounts.Length;
Interlocked.Add(ref m_currentCounts[tid].m_count, signalCount);
// Tally up the total number of signals observed.
int observedCount = 0;
for (int i = 0; i < m_currentCounts.Length; i++)
    {
      observedCount += m_currentCounts[i].m_count;
    }
// Check whether it is signal time, or whether the count has overflown.
if (observedCount > m_initialCount)
    {
// Even if we overflow, we check to see that the event has been set.
if (!IsSet)
      {
        m_event.Set( );
      }
thrownewInvalidOperationException( );
    }
elseif (observedCount == m_initialCount)
    {
// If we were the last to signal, set the event.
      m_event.Set( );
returntrue;
    }
returnfalse;
```

In this code example, each thread calls Signal upon completion. The index is derived from the thread identifier. The method Interlock.Add method is called to update the counter. After updating the counter, the thread iterates through all the array counters to get the current count. If the current count is equal to the initial count, an object is set to pulse all waiting threads. If the current count exceeds the initial count an exception is thrown.

The current count is calculated by iterating through all the counters in the array and sum them as represented in the following code example:

```
publicint CurrentCount
{
get
  {
int currentCount = 0;
for (int i = 0; i < m_currentCounts.Length; i++)
      currentCount += m_currentCounts[i].m_count;
returnMath.Max(0, m_initialCount - currentCount); //Hide overflows.
}
```

In one embodiment, as previously mentioned, the counter memory locations are aligned to cache boundaries. This avoids false sharing that might occur if multiple counter memory locations were within the same cache line. The following represents code that defines the structure of one example counter memory location:

[StructLayout(LayoutKind.Sequential, Size=128)]

```
struct CountEntry
    {
        internal volatile int m_count;
    }
```

Thus, the principles described herein provide an array of counter memory locations that are updated as forked threads complete, thereby reducing opportunity for contention over a single memory location as threads complete. Furthermore, if counter memory locations are assigned along cache boundaries, false sharing is avoided.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more physical computer-readable media having thereon computer-executable instructions that, when executed by one or more processors of the computing system, cause the computing system to perform a method comprising:
an act of determining that a task assigned to a thread is to be divided into a plurality of subtasks to be collectively accomplished by a plurality of forked threads;
an act of setting up a plurality of counter memory locations, each corresponding to only a subset of the forked threads;
for each of the plurality of forked threads, when the forked thread is completed with its corresponding one or more subtasks of the plurality of subtasks, an act of accounting for the completion in a counter memory location corresponding to the forked thread; and
after all of the plurality of subtask have been collectively accomplished by the plurality of forked threads, an act of determining that the plurality of forked threads have completed their respective one or more subtasks using data from each of the plurality of counter memory locations.

2. The computer program product in accordance with claim 1, wherein each of the plurality of counter memory locations corresponds to the size and boundaries of a cache line.

3. The computer program product in accordance with claim 1, wherein the data from each of the plurality of counter memory locations comprises a count of completed threads corresponding to the counter memory location.

4. The computer program product in accordance with claim 3, wherein the act of accounting for the completion in a counter memory location corresponding to the forked thread comprises increment the count held by the counter memory location. corresponding to the forked thread.

5. The computer program product in accordance with claim 1, wherein the method further comprising:
an act of performing a join operation on the plurality of forked threads.

6. The computer program product in accordance with claim 5, wherein the method is recursively performed for at least one of the plurality of forked threads.

7. The computer program product in accordance with claim 1, wherein the number of the plurality of counter memory locations is the same as the number of the plurality of forked threads.

8. The computer program product in accordance with claim 7, wherein each of the plurality of counter memory locations corresponds to a single one of the plurality of forked threads.

9. The computer program product in accordance with claim 1, wherein each of the computer memory locations is implemented as a lock-free memory location

10. The computer program product in accordance with claim 1, wherein the number of the plurality of counter memory locations is more than the number of the plurality of forked threads.

11. The computer program product in accordance with claim 1, wherein a minority of the plurality of counter memory locations do not have a corresponding forked task.

12. A method for performing a thread fork operation, the method comprising:
an act of determining that a task assigned to a thread is to be divided;
an act of identifying a plurality of subtasks that the thread is to be divided into;
an act of assigning each of the plurality of subtasks to a corresponding one of a plurality of subtasks;
an act of setting up a plurality of counter memory locations, each corresponding to only a subset of the forked threads; and
for each of the plurality of forked threads, when the forked thread is completed, an act of accounting for the completion in the counter memory location corresponding to the forked thread.

13. A method in accordance with claim 12, further comprising:
after all of the plurality of subtask have been collectively accomplished by the plurality of forked threads, an act of determining that the plurality of forked threads have completed their respective one or more subtasks using data from each of the plurality of counter memory locations.

14. The method in accordance with claim 13, wherein the data from each of the plurality of counter memory locations comprises a count of completed threads corresponding to the counter memory location.

15. The method in accordance with claim 14, wherein the act of accounting for the completion in a counter memory location corresponding to the forked thread comprises an act of incrementing the count held by the counter memory location. corresponding to the forked thread.

16. The method in accordance with claim 12, wherein each of the plurality of counter memory locations corresponds to the size and boundaries of a cache line to avoid false sharing.

17. The method in accordance in accordance with claim 12, wherein the method further comprising:
an act of performing a join operation on the plurality of forked threads.

18. A computer program product comprising one or more physical computer-readable media having thereon computer-executable instructions that, when executed by one or more processors of the computing system, cause the computing system to perform a method comprising:
an act of determining that a task assigned to a thread is to be divided into a plurality of subtasks to be collectively accomplished by a plurality of forked threads;
an act of initializing a plurality of counter memory locations that corresponding to the boundaries of a cache line, and each corresponding to only a subset of the forked threads;
for each of the plurality of forked threads, when the forked thread is completed with its corresponding one or more subtasks of the plurality of subtasks, an act of increment a count in the counter memory location corresponding to the forked thread; and
after all of the plurality of subtask have been collectively accomplished by the plurality of forked threads, an act of determining that the cumulative counts of all of plurality of counter memory locations equals the total number of the plurality of forked threads.

19. A computer program product in accordance with claim 18, the method further comprising:
an act of determining that all of the plurality of forked subtasks are completed based on the act of determining that the cumulative counts of all of plurality of counter memory locations equals the total number of the plurality of forked threads; and
an act of performing a join operation on the plurality of forked threads in response to the act of determining that all of the plurality of forked subtasks are completed based on the act of determining that the cumulative counts of all of plurality of counter memory locations equals the total number of the plurality of forked threads.

20. A computer program product in accordance with claim 18, the method further comprising:
an act of joining the plurality of forked threads.
